(19) United States
(12) Patent Application Publication
(10) Pub. No.: US 2007/0288988 A1
(43) Pub. Date: Dec. 13, 2007

(54) Cable television system with extended quadrature amplitude modulation signal transmission, transmission means and a management centre therefor

(76) Inventors: Herman Frederik Van Rees, Overslag (NL); Johannes Antonius Maria Oortman, Zevenbergen (NL)

Correspondence Address: Robert Popa, Esq.;c/o LADAS & PARRY, Suite 2100, 5670 Wilshire Boulevard, Los Angeles, CA, 90036-5679, US

(21) Appl. No.: 11/725,173

(22) Filed: Mar. 15, 2007

(30) Foreign Application Priority Data
Mar. 31, 2006 (NL) 1031482
Feb. 16, 2007 (DE) 202007002501.7

(51) Int. Cl. H04N 7/16

(52) U.S. Cl. 725/149

(57) ABSTRACT

A cable television system comprising at least one receiving station and end user terminals connected to the at least one receiving station via a cable television network. The cable television system is provided with transmission means comprising modulation means designed for downstream signal transfer towards the end user terminals and for upstream signal transfer away from the end user terminals. The modulation means are designed for direct quadrature amplitude modulation whereby an information signal that is to be modulated is directly modulated on a carrier wave signal to be transmitted over the cable television network in the frequency range above approximately 100 MHz. The transmission means may be used for long-distance as well as for in-house cable television systems.

### FIELD OF THE INVENTION

The present invention generally relates to cable transmission systems, transmission means for cable transmission systems and management means for cable transmission system. More particularly, the invention relates to cable television systems comprising at least one receiving station and end user terminals connected to at least one receiving station.

### BACKGROUND OF THE INVENTION

Cable television systems, also denoted by the acronym CATV (CAble TeleVision network) or CAI (Central Antenna Installation), originally are long-distance signal distribution networks based on the principle that a large number of geographically spread end user terminals in homes, hotels, offices, and the like are simultaneously provided with (analog) broadcast signals. Broadcast signals, in the present context, are understood to be radio or television programs and other information signals which are promulgated by locally, nationally, or internationally operating radio and television broadcasting organizations or other institutions. The geographical spread of a cable television network usually covers a town, city, or region.

With regard to their structure, the traditional long-distance cable television networks may be subdivided in principle into a main or trunk network, a distribution or local network, and a connection network. The local network, to which the individual end user terminals are connected via the connection network, is connected to a receiving or head end station via the trunk network. The trunk network serves to bridge the sometimes comparatively great distances between the head end station and the various local networks with interposed distribution stations, which are also called local centres. The connection networks nowadays are mostly so-called mini star networks in which the terminal points are connected to the local network in a star arrangement. The local network and the trunk network may be either star-shaped or loop-shaped, the choice being determined in general by the geographical spread and size, i.e. the number of end user terminals, of the relevant cable television network.

Apart from long-distance cable television networks, large buildings such as hotels and office blocks may have their own in-house cable television networks, wherein the signals received through a glass fiber cable, through telephone cables, and/or through a twisted pair cable, etc., by means of a receiving station, also denoted media gateway, are distributed over the individual end user terminals in the building by an in-house cable television network. Such an in-house cable television network may distribute not only the information directly received from the media gateway, but also signals distributed by a long-distance cable television network and its own internally generated signals such as, for example, a hotel television program, pay TV programs such as movies, etc.

The signal transport medium used in mini star networks and in-house cable television networks still is predominantly the coax cable, while the distribution networks are increasingly being fitted with glass fiber cables instead of coax cables. The trunk network is almost entirely built up from glass fiber cables nowadays.

Although the specific construction of cable television systems may vary from one country to another and from one building to another, as may the names given to the various interconnecting stations, the general build-up of such cable television systems corresponds to the structures described above.

Cable television networks were originally designed for analog signal transmission in the known TV frequency bands, which are the VHF (Very High Frequency) band I/III of 47-230 MHz, the UHF (Ultra High Frequency) band IV/V of 300-860 MHz, and the analog FM radio frequency band of 87-108 MHz, within which a number of television and radio channels have been defined in dependence on the bandwidth required for the signal transmission.

Amplitude modulation (AM) is mainly used as the modulation technique in television signal transmission for frequencies up to 860 MHz. Signals in the FM radio frequency band are frequency-modulated, a special form of exponential modulation. Exponential modulation, also denoted angle modulation, covers all modulation techniques known in the art by which not the amplitude of the signal, but the angle (in the case of a vector representation) or the argument (in the case of an exponential notation) is modulated. Exponential modulation methods known from practice are frequency modulation (FM), wherein the carrier wave frequency is varied in the rhythm of the information signal, and phase modulation (PM), wherein the phase of the carrier wave signal is varied in dependence on the information signal. In the case of digitally modulated signals, the term Frequency Shift Keying (FSK) or Phase Shift Keying (PSK) is used, which techniques correspond to FM and PM, respectively, in the context of a pulsed information signal.

It is known that attenuation inevitably occurs when electrical signals are transported. To be able to bridge the (major) distances present in cable television networks, for example in a coaxial connection network and/or a local network, it is necessary to include several amplifiers in a connection. These amplifiers introduce two essential problems into the signal transmission, i.e. noise and intermodulation. Noise and intermodulation adversely affect the signal that is to be distributed. When amplifying a signal, the amplifier adds noise thereto, which detracts from the quality of the signal. Intermodulation arises in the signal as a result of non-linear effects in the amplifier and imposes a restriction on the number of channels that can be transmitted. Non-linearities also give rise to other types of distortion such as, for example, cross modulation. The term intermodulation is also used for the entire range of disturbances and signal distortions caused by non-linear effects.

The strong rise of the Internet has resulted in that since 1995 also data traffic has been exchanged via cable television networks. By means of a so-called cable modem at an end user terminal, such as at a user's home, a data link is established with the local centre or head end station. From there the data traffic is transported further and coupled to the rest of the Internet. The cable company thus acts as an Internet Service Provider (ISP). Cable Internet is a form of broadband Internet.

A range of network protocols is available in practice for the network communication between data processing appliances such as servers and computers, the so-called TCP/IP protocol being used for the Internet. The term TCP/IP indicates a combination of two protocols, the so-called Transmission Control Protocol (TCP) and the Internet Protocol (IP). In terms of the multilayer OSI model (Open System Communication) for data communication, the IP is operative in the network layer 3 and the TCP is operative in the transport layer 4. Other protocols that are active in the transport layer are, for example, UDP (User Datagram Protocol), RTP (Real-time Transport Protocol), and the like. A protocol that is known per se and is active in the network layer 3 is, for example, X.25. Those skilled in the art are familiar with the above and other applicable protocols, so that these protocols require no further explanation within the context of the present invention. In colloquial usage the term IP is used to indicate not only the relevant protocol, but also the Internet traffic as such. The present description uses the term IP both for indicating the relevant protocol and in its general meaning of Internet traffic.

Where originally the signal transmission in a cable television network took place exclusively in downstream direction, i.e. towards an end user terminal, the advent of the Internet traffic has led to a return traffic taking place over the cable television network, i.e. from an end user terminal upstream to a distribution station and/or a receiving station.

In most cases frequencies in the return band of approximately 5 to 23 MHz, 30 MHz, and by now also 65 MHz (lower band) are used for the data traffic from the cable modem to the equipment in the distribution station or local centre and/or receiving or head end station (upstream traffic). This part of the spectrum on the cable television network was never before used for television or radio distribution, partly because it is known for its high pulse noise, irradiation and noise summation, narrow-band interferences (of radio traffic in the 27-MHz band), wide-band Gaussian (thermal) noise, impedance mismatches, and intermodulation. The connection and local networks are provided with special filters and amplifiers tuned to the above return band(s) so as to make the upstream traffic possible.

Cable modems that send their signals upstream, and in particular the system components in the receiving station, have to be robustly designed for coping with the interference sources mentioned above. The result of this is that the frequency efficiency of the modulation technique used is lower in upstream direction than in downstream direction. Typically, a 4-phase modulation technique is used such as QPSK (Quadrature Phase Shift Keying) or D-QPSK (Differential QPSK), and quadrature amplitude modulation such as n-QAM (Quadrature Amplitude Modulation).

D-QPSK offers digital channels of 3 Mbit/s gross in upstream direction. This leads to a net data traffic of approximately 2 Mbit/s after subtraction of the overhead in the data link layer. Approximately 2 MHz bandwidth is used for this in the high-frequency spectrum.

Quadrature amplitude modulation means for use in the return band of a cable television network are known from German patent application DE 199 39 588 and international patent application WO 01/52492. The quadrature amplitude modulation means described in these publications are limited to the use in the frequency range of approximately 5 MHz to 65 MHz owing to the absence of an IF stage and a so-called RF up-converter. n-QAM is essentially a combination of AM and PSK with two carrier waves whose phases are mutually orthogonal, the in-phase signal (I) and the quadrature signal (Q). The phase constellation or bit load of a QAM signal is indicated by the number n, which can vary from, for example, n=16 for a present-day cable internet modem to, for example, n=32, 64, 128, or 256, where n=256 is used, for example, for the transfer of digital television signals which may be coded, for example, in accordance with the MPEG (Motion Picture Expert Group) standard, such as MPEG-2 or MPEG-7, etc. The signals thus coded and modulated are exchanged over the cable television network in a time-multiplexed mode. An n-QAM signal may be superimposed on an existing carrier wave of a television or radio channel in the cable television network.

Increasingly, digital techniques are being exclusively used in the glass fiber trunk network from the head end station to one or more distribution stations or local centres. A number of information signals to be distributed, generally a multiple of five, is joined together in coded form in MPEG format into a so-called transport stream by a multiplexer. Different multiples can be distributed in this manner, depending on the capacity of the glass fiber cable connection.

Before a transport stream can be distributed as an information signal over the cable television network, it is subjected to a number of operations. Quadrature amplitude modulation n-QAM is preferably used, wherein n can be set (n=16, 32, 64, 128, 256, 1024, or higher). This modulation process takes place at a fixed, relatively low frequency, usually 36.15 MHz. The result obtained at this frequency is denoted the IF (Intermediate Frequency) signal. This IF signal should subsequently be mixed upward as regards its frequency in a so-called up-converter to obtain the eventual cable frequency, i.e. of the radio frequency channel or the radio carrier wave, also denoted RF (Radio Frequency). The latter process is technically complicated and laborious, and accordingly relatively expensive. It also requires a considerable amount of space in a head end station for accommodating the necessary equipment. The use of n-QAM in a cable television network, however, offers an enormous increase in capacity, in particular for the transfer of digital information signals.

In addition to television and radio signals, whether analog or digital for reception with separate TV and radio sets and internet data traffic, cable television networks nowadays offer a variety of services such as telephony, telemetry but also digital cable TV for direct display on a Personal Computer (PC), e.g. in accordance with the DVB-C (Digital Video Broadcasting-Cable) standard. The exchanged information signals each have their own specific signal and application characteristics, for example transmission in real time for telephony and interactive services or delayed transmission in the case of telemetry data and so-called streaming data for DVB-C.

Not only does the number of services grow, the transport capacity of the various services also increases owing to improved or different signal distribution and modulation techniques and equipment. Thus it is expected that the speed of Internet traffic will rise from 2 Mbit/s to, for example, 50 or even 100 Mbit/s in the coming years, and that a 1024-QAM modulation technique will become possible for digital signal transmission.

Many billions of euros have been invested in present-day cable television systems for more than 6 million connections in the Netherlands alone, for example. Voices are heard expressing doubt as to whether the necessary increase in signal distribution capacity, in particular in downstream direction, can still be realized with the use of the present infrastructure. The main boundary condition is that it should be possible to realize this increase without (major) modifications to the coaxial cable network present in the ground and the associated amplifiers and distribution stations or local centres. This is not possible with the present technical equipment used in a cable television system. The practical solution suggested is, therefore, to use glass fiber cables not only in the trunk network and the local network, but even right up to the end user terminal.

The cable television networks in buildings such as hotels and office blocks mentioned above are also mainly built up from coax cables. The demand for data exchange capacity for communication and telemetry purposes, in particular for security purposes, in addition to Internet data traffic is a growing one also in hotels and companies.

A replacement of the coax cables with glass fiber cables or the construction of an additional glass fiber network next to the existing coax cable network not only requires a considerable expenditure, but it also involves a practical inconvenience caused by the laying of new cables. Any repair of glass fiber cables, moreover, is still a costly and time-consuming business compared with the repair of coax cables.

### SUMMARY OF THE INVENTION

The invention, in a first aspect thereof, has for its object to provide an extension possibility for the existing information signal transmission in a cable television system such that the existing coaxial cable network infrastructure can still be used, in particular in downstream direction. The expression information signal transmission in the present description and invention denotes essentially all signal transmissions in a cable television system, including data traffic.

According to the invention, this object is achieved in that modulation means for direct quadrature amplitude modulation (DirectQAM™) are included in the cable television system, which means are designed for directly modulating an information signal on a carrier wave signal to be transmitted by the cable television system in a frequency range above approximately 100 MHz.

The invention is based on the recognition that, if the expected demand for a still higher information transfer capacity of existing cable television networks is to be met, quadrature amplitude modulation (n-QAM) is highly suitable. Due to their enormous physical bulk and associated high cost, however, the present indirect n-QAM means comprising an IF intermediate stage and RF up-conversion unsuitable for use on a large scale. Their use accordingly remains limited to head end stations for the transmission of signals between a head end station and one or more local centres or distribution stations.

Unlike the cited German patent application DE 199 39 588 or the international patent application WO 01/52492, the invention thus provides direct quadrature amplitude modulation means with direct modulation of the information signal on a carrier wave signal that is to be distributed over the cable television network in the frequency range above approximately 100 MHz, which implies that the voluminous and expensive RF up-converter can be omitted. The construction of the direct quadrature amplitude modulation means according to the invention can be much more compact and economical now, while at the same time the technical specifications are improved. The advantages thereof are self-evident: less bulky equipment, a higher information transport capacity and versatility to the end user terminals, and a saving of cost.

Direct quadrature amplitude modulation means suitable for use according to the invention, also denoted DirectQAM™ hereinafter, are developed by and are available from the Analog Devices Company. These circuits are remarkable on account of their small dimensions as well as their very low energy consumption compared with the known indirect QAM modulation means (with RF up-converter).

The direct quadrature amplitude modulation means may advantageously be constructed as an integral unit together with the associated transmission means in the form of one (or a few) ASIC(s) (Application-Specific Integrated semiconductor Circuit) or FPGA(s) (Field Programmable Gate Array).

Owing to the much smaller dimensions of the direct quadrature amplitude modulation means, occupying only a fraction of the space of the present indirect quadrature amplitude modulation means for frequencies above 100 MHz, the invention in a further embodiment provides that transmission means comprising direct quadrature amplitude modulation means for carrier wave frequencies above 100 MHz are arranged in the at least one receiving station and/or in at least one distribution station or local centre.

In a preferred embodiment of the invention, the direct quadrature amplitude modulation means are designed for information signal transfer on a carrier wave signal, for example of a free channel, in a signal spectrum that is to be transmitted to an end user terminal via the connection network, for example in the UHF band discussed above or in general between approximately 100 and 860 MHz. As a result, the existing infrastructure of a cable television network built up from coax cables can advantageously remain in use while still the envisaged extension of the signal distribution capacity in downstream direction is realized, as discussed above.

When the direct quadrature amplitude modulation means (DirectQAM™) according to the preferred embodiment of the invention are included in a head end station, the relevant n-QAM information signal can be distributed in a local centre to the end user terminals without further demodulation/modulation of the signal received from the head end station. This obviously does not hold for the conversion of the optical signal for transmission over the trunk network into an electrical signal that is to be transmitted via the local network and the connection network.

When the direct quadrature amplitude modulation means according to the invention are placed in a distribution station or a local centre, the information signal that is to be modulated by the direct quadrature amplitude modulation means may be directed via the trunk network to the relevant local centre and/or may be directly applied to the direct quadrature amplitude modulation means at the local centre. The latter situation may relate to, for example, an information signal exchange having a local character.

Owing to the small dimensions of the direct quadrature amplitude modulation means according to the invention, an embodiment thereof also provides that at least one end user terminal of the cable television system is connected to or is provided with transmission means comprising direct quadrature amplitude modulation means, while the connection network is designed for return transmission at a frequency not lying in the return band (5 to 23 MHz, 30 MHz, and at present also 65 MHz), for example a frequency in the so-called superband above 860 MHz. Obviously, the direct quadrature amplitude modulation means are then adjusted for transmission on a carrier wave signal that lies within the relevant superband.

Such an embodiment is particularly interesting, for example, for use with cable television networks in buildings such as hotels and office blocks.

In an embodiment of the invention, furthermore, at least one management or control centre situated locally in a distribution or receiving station or at a distance therefrom is operatively connected to the direct quadrature amplitude modulation means for adjusting and monitoring the operational settings of the modulation means, such as inter alia the output frequency, the phase constellation n, the modulation symbol speed, the roll-off factor, the RF output level, and various other operational and system parameter settings.

Such a management centre or centres can effectively control and monitor the signal exchange in the cable television network so as to safeguard a signal transfer that is unhampered as much as possible, which is a very important requirement in today's information society which is dependent on a reliable and continuous information exchange.

It will be understood that the information exchange between the management centre and the direct quadrature amplitude modulation means (DirectQAM™) according to the invention may take place by means of any suitable data link, both wired and wireless, in particular via an IP link.

The invention also relates to a management centre as described above.

The invention further relates to transmission means comprising digital data processing means and quadrature amplitude modulation means, in particular for use in cable television networks, wherein the quadrature amplitude modulation means are designed for direct quadrature amplitude modulation of a digital information signal processed by the data processing means so as to modulate the digital information signal directly on a carrier wave signal in the frequency range above approximately 100 MHz. In a preferred embodiment of the transmission means according to the invention, the direct quadrature amplitude modulation means are designed for directly modulating the information signal on a carrier wave signal within the frequency band of approximately 100 to 860 MHz as used for cable television networks.

For use in or with a connection network in a cable television network for long distances and/or a cable television network in buildings such as hotels and office blocks and the like, the invention in a yet further embodiment provides that the direct quadrature amplitude modulation means are designed for directly modulating the information signal on a carrier wave signal in the frequency superband above approximately 860 MHz as used for cable television networks.

For the particular purpose of transmitting digital cable television signals that are to be directly displayed on a PC or other digital computer or digital processor, the invention provides an embodiment of the transmission means wherein the direct quadrature amplitude modulation means are designed for directly modulating the information signal on a carrier wave signal in accordance with the DVB-C (Digital Video Broadcasting-Cable) standard developed for cable television networks.

Since the transmission means can be constructed entirely or for the major part in the form of an application-specific integrated semiconductor circuit, ASIC or FPGA, a preferred embodiment of the transmission means according to the invention provides that the data processing means and the direct quadrature amplitude modulation means are designed for processing a plurality of information signals on a plurality of carrier wave signals or channels, in particular a plurality of one to four channels. The transmission capacity of a cable television network can be increased thereby in blocks of four channels in a simple, modular manner.

Providing the data processing means with optical to electrical conversion means, in a still further embodiment of the transmission means, renders it advantageously possible to convert an optical digital information signal applied to the input of the transmission means directly into a quadrature amplitude modulated signal for distribution via a cable television network, in particular a coaxial cable television network. The transmission means are advantageously provided with at least one coaxial output connector in this case.

In an embodiment of the transmission means according to the invention, the data processing means comprise digital synchronization means in a cascade arrangement for separating a synchronization byte from the incoming digital information signal, digital coding means for coding the digital information signal for further processing, for example by means of a Reed-Solomon FEC code that is known per se, and digital format adaptation and imaging means by which the data format of the digital information signal is adapted to the phase constellation (n) of the direct QAM modulation that is to be carried out. Mapping also takes place, i.e. the phase and amplitude of the RF vector of the direct quadrature amplitude modulation means belonging to the data format to be modulated are determined.

Those skilled in the art will appreciate that the transmission means may comprise further circuits necessary for the operation thereof, among them a clock control circuit, oscillator circuits for generating a carrier wave, etc. These, however, are components known to those skilled in the art which do not require any further explanation in the context of the present invention.

The transmission means may further advantageously be provided with a control or operational input providing a remote control possibility of various parameter settings of the transmission means.

The invention also relates to a coaxial cable transmission system in a building, such as a hotel or an office block, comprising one or more transmission means according to the invention as discussed above.

The invention will be explained in more detail below with reference to the accompanying figures.

### BRIEF DESCRIPTION OF THE DRAWINGS

FIG. 1 schematically shows the typical construction of an existing, prior art long-distance cable television system.

FIG. 2 schematically shows a cable television network according to FIG. 1, with transmission means comprising direct quadrature amplitude modulation means according to the invention accommodated in a receiving station therein.

FIG. 3 schematically shows a cable television network according to FIG. 1, with transmission means comprising direct quadrature amplitude modulation means according to the invention accommodated in a distribution station, as well as a management centre.

FIG. 4 schematically shows a cable television network according to FIG. 1, with transmission means comprising direct quadrature amplitude modulation means according to the invention accommodated in an end user terminal.

FIG. 5 is a basic diagram of an embodiment of transmission means provided with direct quadrature amplitude modulation means according to the invention.

FIG. 6 is a detailed block diagram of an embodiment of transmission means provided with direct quadrature amplitude modulation means according to the invention.

FIG. 7 schematically shows a cable transmission system in a building, such as an office block or a hotel, according to the invention equipped with transmission means with direct quadrature amplitude modulation means.

### DETAILED DESCRIPTION OF PREFERRED EMBODIMENTS

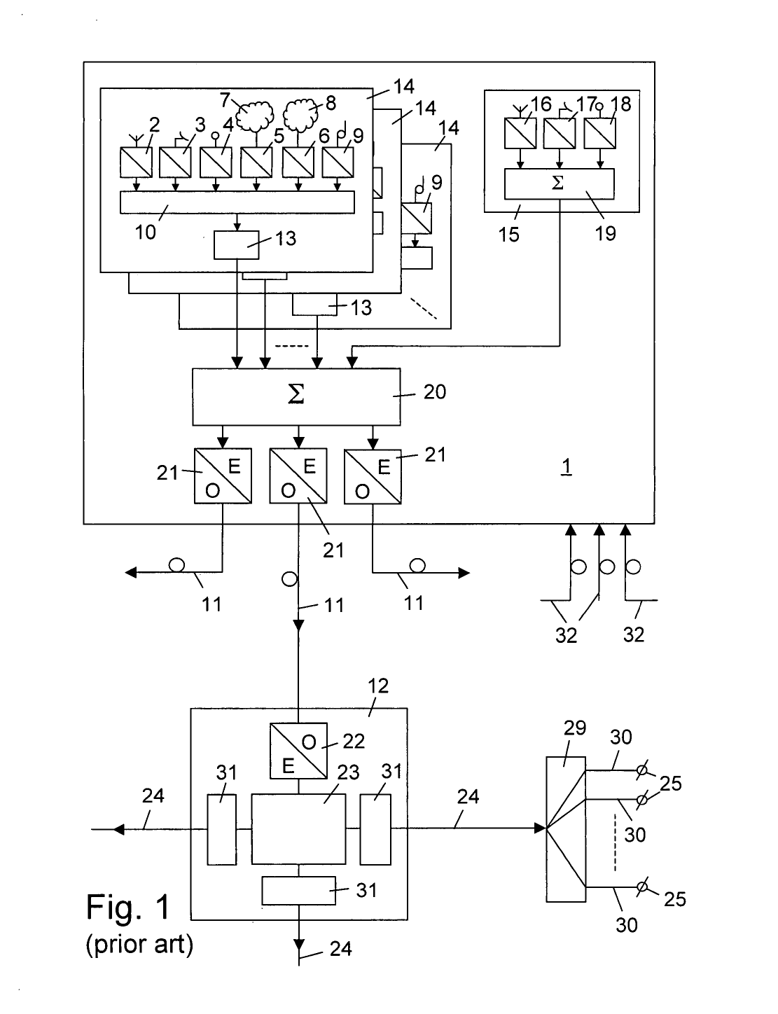

FIG. 1 schematically shows the typical construction of a cable television system for the distribution of broadcast signals, such as radio and television programs and other information signals which are received in a receiving or head end station 1, or of input data signals.

The signals are joined together in the receiving or head end station 1 for downstream transfer, i.e. away from the head end station 1 towards one or more distribution stations or local centres 12 via a trunk network 11 built up from glass fiber cables. From a distribution station or local centre 12, the signals are eventually delivered via a local or distribution network 24 and a connection network 30 to end user terminals 25 at subscribers' homes or offices, etc.

Reception and conversion means 2 are arranged in the head end station 1 for receiving signals transmitted by terrestrial transmitters, as are reception and conversion means 3 for receiving signals transmitted by satellite transmitters, and reception and conversion means 4 for distributing radio and television programs and other services, including digital radio and television signals offered, for example, via a cable or otherwise, for example from a local studio. Reference numerals 5 and 6 denote means for data exchange, for example Internet traffic 7 and other data traffic 8. Reference numeral 9 indicates reception means designed, for example, for data exchange with another receiving or head end station (not shown). The reception and conversion means 2 to 9 supply digital signals, for example signals coded in accordance with the MPEG format.

A multiple of five MPEG-coded signals is joined together by a multiplexer into a so-called transport stream.

Behind the multiplexer 10, as viewed in downstream direction, there are modulation means 13 for modulating the output signal of the multiplexer 10 on a carrier wave signal. The prior art uses for this purpose inter alia indirect quadrature amplitude modulation means (n-QAM) with an IF intermediate stage and an RF up-converter, as was discussed in the introduction.

A number m of modules 14 consisting of reception and conversion means 2 to 9, a multiplexer 10, and modulation means 13 may be arranged in the head end station 1, the modulation means 13 of the individual modules being designed for transmission on mutually differing carrier wave signals.

The reference numeral 15, furthermore, indicates an analog signal transmission module provided with analog reception and conversion means 16, 17, and 18 which are joined together by RF summation means 19 into an RF signal spectrum for transmission over the trunk network 11.

The digital signals originating from the modules 14 and, if necessary, the analog signals from the module 15 are joined together by RF summation means 20 into a single RF signal spectrum in the receiving or head end station 1 for downstream transfer over the trunk network 11. Conversion means 21 which are known per se are provided for this, comprising a laser or similar element for converting the electrical (E) output signal of the RF summation means 20 into an optical (O) signal for transmission over the glass fiber trunk network 11.

The trunk network 11 ends each time in a distribution station or local centre 12, where the incoming optical signal is converted from an optical (O) signal into an electrical (E) signal by conversion means 22 that are known per se, so as to be further processed and distributed to end user terminals 25 via a local network 24 that is usually still built up from coaxial cables. The end user terminals 25 are coupled to the local network 24 by means of a connection network 30 constructed from coaxial cables and a so-called mini star distribution element 29. The various sections of the connection network 30 each form a so-called mini star section.

In a distribution station or local centre 12 there is usually a distribution amplifier 23 for exchanging signals with the end user terminals 25 via the local network 24. An amplifier 31 may be connected in a local network section 24 for offering the signals downstream to the end user terminals at a desired level.

For reasons of clarity, FIG. 1 shows only a limited number of sections of the trunk network 11, a limited number of sections of the local network 24, a single local centre 12, and a limited number of end user terminals 25 and amplifiers 31. It will be appreciated that more or fewer sections and more local centres, end user terminals, and amplifiers may be present, that more and other means for signal exchange are possible in a receiving or head end station 1, and that even mutually different receiving or head end stations 1 may be provided.

The local amplifiers 31 are constructed for two-way signal transmission for return traffic from an end user terminal 25 to the local centre 12, i.e. upstream signal transmission; downstream traffic using, for example, a frequency range of approximately 100 to 860 MHz and upstream traffic, for example, a frequency range of approximately 5 to 65 MHz. Upstream traffic from a local centre 12 to a head end station 1 takes place over separate glass fiber connections nowadays, which is schematically indicated merely by the reference numeral 32 in FIG. 1 for reasons of clarity. It will be appreciated that the head end station 1 further comprises suitable reception means (not shown). Return traffic consists of, for example, data traffic such as Internet traffic, domotica signals and telephone traffic.

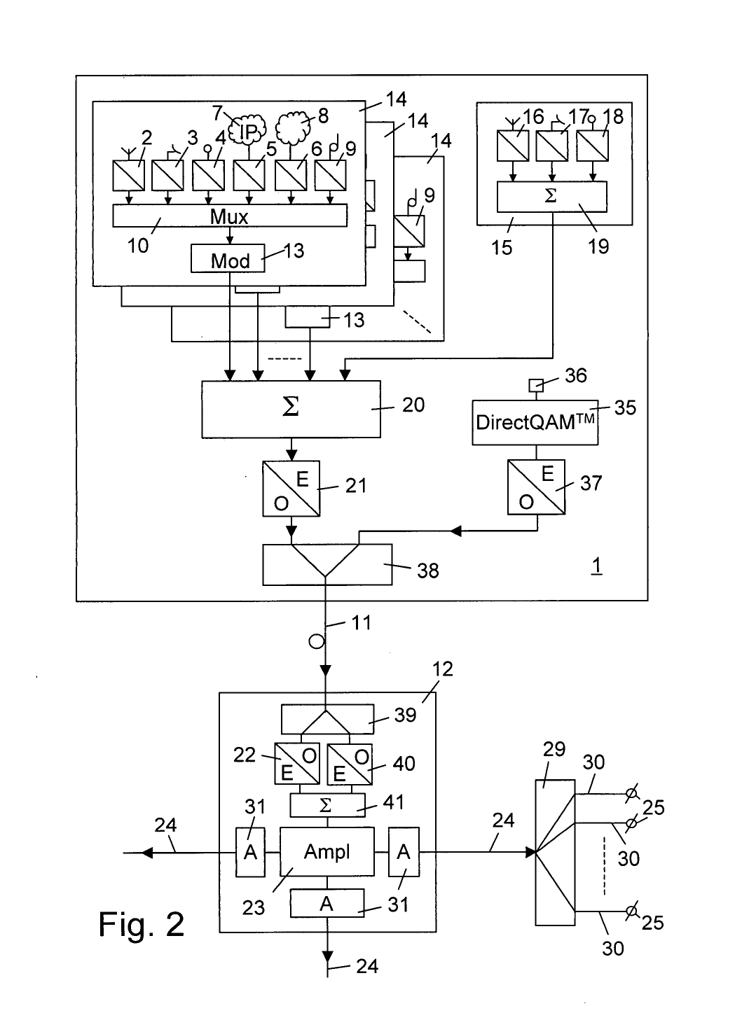

FIG. 2 shows an embodiment of the invention in which additional transmission means with direct quadrature amplitude modulation means (DirectQAM™) 35 are arranged in the head end station 1 and are designed for directly modulating a carrier wave signal for signal transmission in a frequency range above approximately 100 MHz. The output signal (n-QAM) modulated by the direct quadrature amplitude modulation means 35 based on information signals applied to a connection terminal 36 of the means 35 is converted from an electrical (E) into an optical (O) signal by conversion means 37, comprising a laser or similar element, for transmission over the glass fiber trunk network 11. Depending on the construction of the trunk network, the optical signals of the converters 21 and 37 may each be joined together or multiplexed on a different colour in a manner known per se, as is schematically indicated in FIG. 2. Optical means 38 are provided for this purpose. It is obviously alternatively possible to transmit the optical signal of the conversion means 37 separately from the signals of the conversion means 21 through a separate optical fiber.

For receiving and converting the signal coming from the direct n-QAM means 35, the arrangement of FIG. 2 provides optical splitter means 39 in a relevant distribution station 12, followed in downstream direction by conversion means 40 for converting the received optical signal into an electrical signal. The fact that the direct quadrature amplitude modulation means 35 modulate the output signal on an RF carrier wave lying in the frequency spectrum of the signal that is to be transmitted over the local or distribution network 24 and the connection network 30, i.e. the frequency band between approximately 100 and 860 MHz, means that the electrical signal from the conversion means 40 can be directly transferred to the end user terminals 25 via the distribution amplifier 23 and, if necessary, an amplifier 31.

FIG. 2 shows the situation in which also the signal of the n-QAM modulation means 13 in the receiving or head end station 1 is modulated on a carrier wave lying in the frequency spectrum of the signal that is to be transmitted over the local or distribution network 24 and the connection network 30, so that the signals from the conversion means 22 and 40 can be joined together in a simple manner in a distribution station 12 for distribution to the end user terminals 25 by RF summation means 41.

The capacity for the transmission of signals over the cable television system can thus be increased by the direct n-QAM means 35 according to the invention in a comparatively simple, inexpensive and energy-efficient arrangement that occupies relatively little physical space. Obviously, the n-QAM means 13 in the head end station 1 may also advantageously be replaced by direct n-QAM means 35 (DirectQAM™) according to the invention.

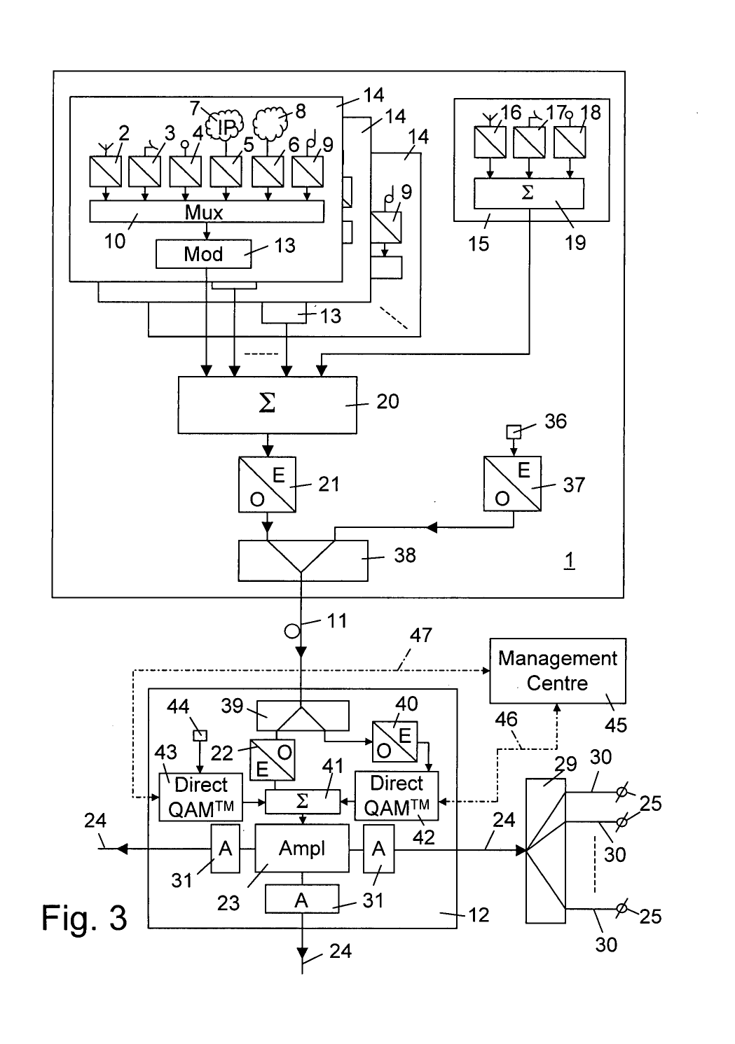

FIG. 3 illustrates an embodiment of the invention wherein direct quadrature amplitude modulation means 42, 43 (DirectQAM™) are included in a distribution station 12. Signals received at an input terminal 36 from the head end station 1 are directly applied to the conversion means 37 here for transmission over the trunk network 11 as discussed above. In the distribution station, the received electrical signal is converted by the conversion means 40 and modulated by the direct quadrature amplitude modulation means 42 on a carrier wave signal for transmission to the end user terminals 25.

Reference numeral 43 indicates direct n-QAM means according to the invention for the distribution to end user terminals of digital information signals offered locally in the distribution station 12, for example at an input terminal 44, these being, for example, information signals having a local character. Their energy efficiency and small space requirement mean that the direct n-QAM means 42, 43 according to the invention can be accommodated in a distribution station 12 without the necessity of reconstructions or other spatial extensions. The invention accordingly renders it possible to add an extra signal transmission capacity to the cable television system in a flexible manner.

It will be appreciated that more or fewer transmission means with direct quadrature amplitude modulation above approximately 100 MHz may be included in various locations in the cable television network. This is dependent on, among others, the specific demand for information exchange.

Those skilled in the art will understand that, although this is not shown, the cable television network and/or the equipment connected thereto, such as the means at a users end terminal 25, comprises suitable digital receiving and decoding means for receiving, demodulating and decoding n-QAM signals. Such receiving, demodulating and decoding means are known per se to those skilled in the art and require no further explanation here.

A control or management centre 45 is shown for remote control of the DirectQAM™ means according to the invention, with couplings 46, 47 to the direct n-QAM means 42, 43. It will be appreciated that the couplings 46, 47 for the transmission of control and command signals between the management centre 45 and the direct n-QAM means 42, 43 may be realized in various manners known to those skilled in the art. Besides fixed connections, for example via the telephone network, wireless remote control links via the mobile telephone network and the like are also feasible. IP-controlled commands may be advantageously used. Signal exchange over the cable television network itself is obviously also possible. It will be understood that, although this is not shown, the management centre 45 may also be coupled to the direct n-QAM means 13, 35 in a receiving or head end station 1 (cf. FIG. 2).

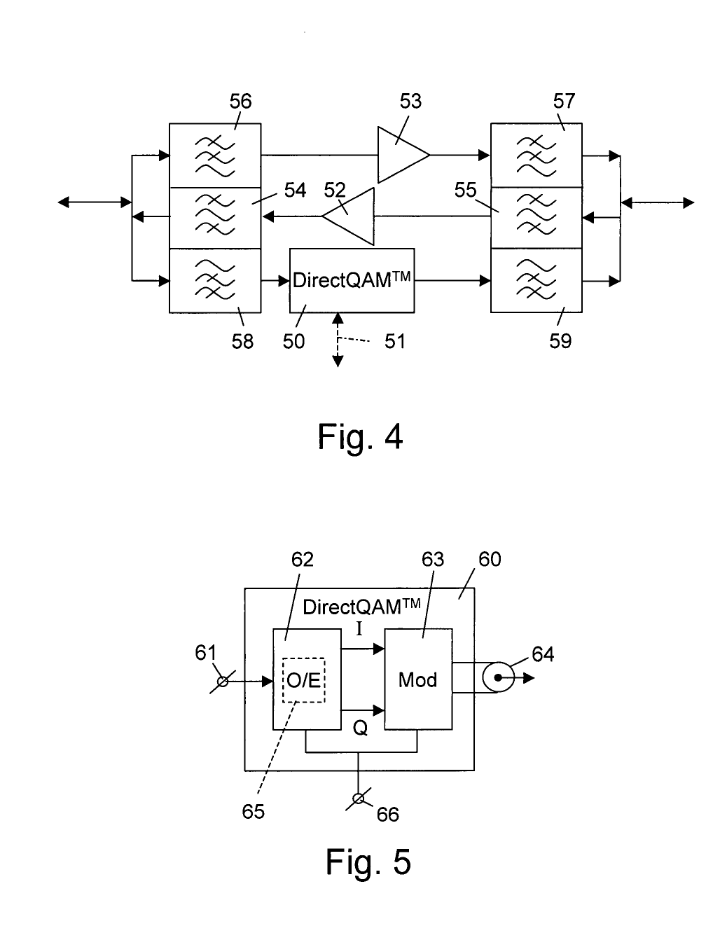

FIG. 4 shows an embodiment of the invention in which direct quadrature amplitude modulation means 50 according to the invention are arranged in the connection network 30, in the local or distribution network 24, or at an end user terminal 25 so as to provide an additional return capacity upstream in the cable television network.

Since both the local or distribution network 24 and the connection network 30 are built up mainly from coaxial cables, amplifiers 52 for downstream traffic and amplifiers 53 for upstream traffic are present therein. It is ensured by means of band filters 54, 55 that the amplifier 52 amplifies only traffic in the frequency band of, for example, approximately 100 to 860 MHz. Band filters 56, 57 are arranged such that the amplifier 53 amplifies only return traffic (upstream) in the frequency band of, for example, approximately 5 to 65 MHz.

According to the invention, band filters 58, 59 are provided which transmit signals in the superband, i.e. above approximately 860 MHz. The direct n-QAM means 50 are arranged for directly modulating information signals on a carrier wave signal in the superband for transfer to a distribution station or local centre 12. Means may be provided in the distribution station 12 for transmitting the return traffic upstream to the receiving or head end station 1, if so required, or for processing the return traffic in a distribution station 12 itself, for example. A hitherto unimaginable increase in the digital return capacity in the cable television network can thus be achieved in a simple manner, not only in upstream direction, but if required also in downstream direction, for example in the superband.

The direct n-QAM means 50 may also be remotely controlled from the management centre 45 via a control or command line 51, which leads to a particularly flexible and low-maintenance system.

FIG. 5 shows the basic circuit of an embodiment of transmission means provided with direct quadrature amplitude modulation means (DirectQAM™) according to the invention, collectively indicated with the reference numeral 60.

The transmission means 60 comprise digital data processing means 62 and connected thereto the direct quadrature amplitude modulation means 63 as developed and supplied by the Analog Devices company.

The data processing means 62 are preferably arranged such that IP data can be directly applied to the input 61 of the transmission means 60, which data are then processed for providing a quadrature amplitude modulation signal to an output 64 of the transmission means 60 for use in a cable television network, with a carrier wave signal above approximately 100 MHz and preferably in the frequency band of approximately 100 to 860 MHz and/or in the superband above approximately 860 MHz. The output terminal 64 is preferably constructed as a coaxial connector for direct connection to a coax cable.

Reference numeral 65 denotes optional optical (O) to electrical (E) conversion means which render it advantageously possible to convert an optical digital information signal applied to the input 61 of the transmission means 60 directly into a quadrature amplitude modulated signal for distribution via a cable television network, in particular a coaxial cable television network, via the coaxial output connector 64.

The transmission means 60 may be arranged for processing a plurality of information signals on a plurality of carrier wave signals or channels, in particular a number of four channels, for a modular extension of the transmission capacity of a cable television network.

Reference numeral 66 denotes a schematically depicted control or command input of the transmission means 60 for achieving a remote control by means of, for example, an IP link or the like from a management centre 45, for monitoring and adjusting various parameter settings of the transmission means 60.

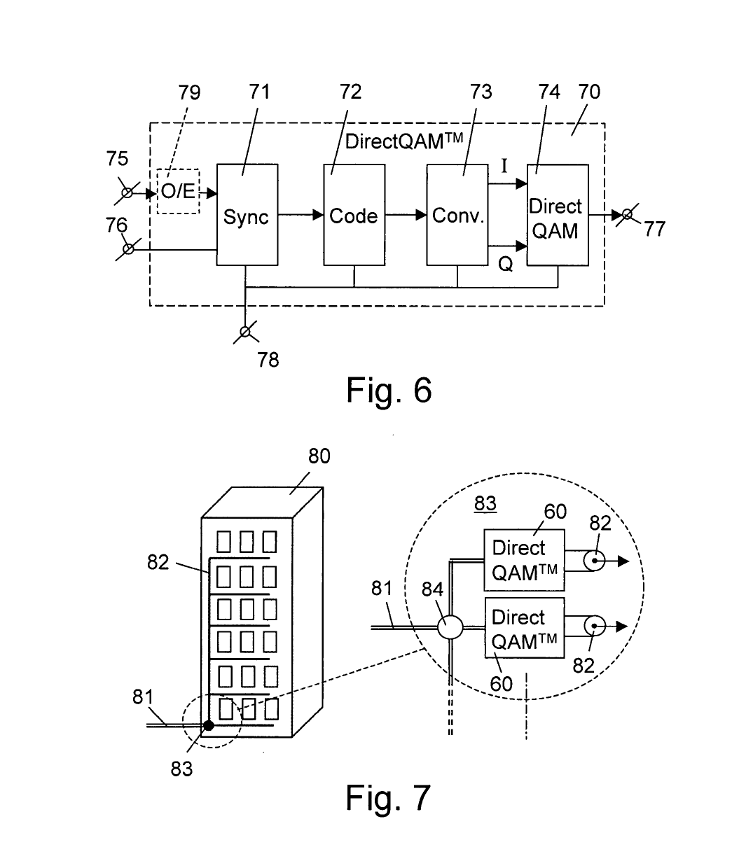

FIG. 6 is a detailed block diagram of an embodiment of the transmission means provided with direct quadrature amplitude modulation means according to the invention, collectively referenced 70. The DirectQAM™ means 70 are formed by a cascade circuit comprising blocks 71 to 74.

Block 71 is mainly designed for and operative in separating a synchronization byte from a digital information signal that is to be modulated and that is applied to data input 75. For example, every 8th synchronization byte is inverted, and the spectral energy distribution or dispersal is also added thereto. Input 76 is a clock input for a clock signal, which is known per se.

Block 72 is designed for and operative in coding the digital signal, for example by means of a Reed-Solomon FEC-code, which is known per se. Herein, 16 bytes RS(204, 188) are added to a frame of 188 bytes. This renders it possible to correct 8 damaged bytes at the receiving side. This block also contains a so-called convolutional bit interleaver. Bit interleaving provides a protection against burst errors. This essentially comprises a suitable rearrangement of the bits through transposition or in a matrix arrangement.

In block 73, the byte-width data format is converted into data of N bits width, for which it holds that N=2 Log(64) in the case of 64-QAM modulation, for example. Mapping also takes place here. Mapping means assigning the phase and amplitude of the RF vector belonging to the N-bits wide data that go to the modulator. The block 73 generates and I and Q output signal in accordance with the quadrature amplitude modulation technique. This block also provides differential coding, which has the result that it is not the absolute phase and amplitude of the vector that are important, but the difference compared with the previous vector position.

Block 74, finally, represents the direct quadrature amplitude modulation means with, for example, n=64, 128, 256, 1024 according to the invention, wherein modulation takes place directly on the RF carrier wave of a cable television channel in the frequency range above approximately 100 MHz, i.e. without an IF intermediate stage and without an RF up-converter according to the prior art. The modulated signal to be exchanged on the selected RF carrier wave or the RF cable channel over the cable television network is available at an output 67 of the direct quadrature amplitude modulation means 60.

Reference numeral 78 denotes a command or control input for a remote control, for example by means of a management centre 45, of various settings of the transmission means 70, such as inter alia the carrier wave output frequency, the phase constellation (n), the modulation symbol speed, the roll-off factor, the RF output level, and various other operational and system parameter settings of the direct quadrature amplitude modulation means.

Reference numeral 79 denotes optional optical (O) to electrical (E) conversion means which render it advantageously possible to convert an optical digital information signal applied to the input 75 of the transmission means 70 directly into an electrical quadrature amplitude modulated signal.

The transmission means 70 may be entirely constructed as an application-specific integrated semiconductor circuit, ASIC or FPGA, schematically indicated by a surrounding broken line.

FIG. 7 shows the application of direct quadrature amplitude modulation means according to the invention in a cable transmission system in a building, such as an office block or a hotel 80. In the building 80, a coaxial cable network 82 is installed over which television signals and other information signals can be exchanged as discussed above with reference to the long-distance cable television network. The coaxial cable network 82 is also provided with amplifiers, filters and the like, which are not explicitly shown for the sake of clarity.

The signals to be distributed over the cable network may originate from a long-distance cable network, or they may alternatively be supplied directly, for example by a telecom operator via a glass fiber cable, a twisted-pair cable, etc. 81 from a media gateway or other receiving station. Signals internally generated in the building may also be distributed via the cable network 82, for example a hotel TV channel.

According to the invention, one or more transmission means for direct quadrature amplitude modulation may be installed in the connection terminal 83, where the incoming signals are offered to the cable television network via e.g. a glass fiber cable, for example the transmission means 60 discussed above and depicted in FIG. 5. The transmission means 60 receive their input signal from the incoming cable through suitable splitter means 84. The output of the transmission means 60 is connected in a known manner to the coaxial cable network 82 of the building 80. FIG. 7 shows this arrangement for a building, wherein that which falls within the scope of the invention is shown on an enlarged scale encircled by a broken line.

The architecture shown in FIG. 7 presents a telecom operator with the possibility, for example, to offer IP television signals and other services on existing coaxial in-house cable networks in office blocks, hotels, etc., without substantial adaptations to the structure and installation of the in-house cable network 82 being necessary for this.

Summarizing, the invention provides an increase in the transmission capacity for digital information signals over cable networks built up from coaxial cables, preparing them for future requirements as regards transmission capacity and speed, without the necessity of major investments in glass fiber cables or physical space, all this in an energy-efficient manner.

The invention is, as will be appreciated by those skilled in the art, not limited to the embodiments disclosed above. Those skilled in the art may modify and implement the invention without having to apply inventive skills. The attached claims intend to comprise all such modifications.

1. A cable television system comprising at least one receiving station and end user terminals connected to said at least one receiving station, said cable television system being designed for downstream signal transport in a direction towards said end user terminals and for upstream signal transport in a direction away from said end user terminals, comprising modulation means for direct quadrature amplitude modulation, said modulation means being arranged for directly modulating an information signal on a carrier wave signal to be transmitted by said cable television system in a frequency range above approximately 100 MHz.

2. A cable television system according to claim 1, wherein said at least one receiving station is provided with transmission means comprising said modulation means for direct quadrature amplitude modulation.

3. A cable television system according to claim 1, wherein said end user terminals connect to said at least one receiving station by at least one distribution station, and in that said at least one distribution station is provided with transmission means comprising said modulation means for direct quadrature amplitude modulation.

4. A cable television system according to claim 1, wherein at least one end user terminal is provided with transmission means comprising said modulation means for direct quadrature amplitude modulation.

5. A cable television system according to claim 1, wherein said modulation means for direct quadrature amplitude modulation are arranged for modulating said information signal on a carrier wave signal in a frequency spectrum that is to be delivered at an end user terminal.

6. A cable television system according to claim 1, wherein said carrier wave signal is in a frequency band of approximately 100 to 860 MHz.

7. A cable television system according to claim 1, wherein at least a portion of said cable television network is designed for upstream signal transmission from an end user terminal to a receiving station in a superband above approximately 860 MHz, and in that said modulation means for direct quadrature amplitude modulation are arranged for information signal transfer on a carrier wave signal in said superband.

8. A cable television system according to claim 1, wherein said modulation means for direct quadrature amplitude modulation and transmission means comprising said modulation means for direct quadrature amplitude modulation are constructed in the form of any of a group comprising an Application Specific Integrated semiconductor Circuit (ASIC) and a Field Programmable Gate Array (FPGA).

9. A cable television system according to claim 1, wherein at least one management centre operatively connects to said modulation means for direct quadrature amplitude modulation, for the purpose of adjusting and monitoring operational settings of said modulation means.

10. A cable television system according to claim 9, wherein said at least one management centre is arranged for adjusting at least one of output frequency, phase constellation, modulation symbol speed, roll-off factor, RF output level, and other operational and system parameters of said modulation means for direct quadrature amplitude modulation.

11. A management centre arranged for adjusting at least one of output frequency, phase constellation, modulation symbol speed, roll-off factor, RF output level, and other operational and system parameters of modulation means for directly modulating an information signal on a carrier wave signal to be transmitted in a frequency range above approximately 100 MHz in a cable television system comprising at least one receiving station and end user terminals connected to said at least one receiving station.

12. Transmission means comprising digital data processing means and quadrature amplitude modulation means, in particular for use in cable television networks, wherein said quadrature amplitude modulation means are arranged for directly modulating a digital information signal processed by said data processing means on a carrier wave signal to be transmitted in a frequency range above approximately 100 MHz.

13. Transmission means according to claim 12, wherein said quadrature amplitude modulation means are arranged for directly modulating said information signal on a carrier wave signal in a frequency band of approximately 100 to 860 MHz used for cable television networks.

14. Transmission means according to claim 12, wherein said quadrature amplitude modulation means are arranged for directly modulating said information signal on a carrier wave signal in a frequency superband above approximately 860 MHz used for cable television networks.

15. Transmission means according to claim 12, wherein said quadrature amplitude modulation means are arranged for directly modulating said information signal in accordance with a Digital Video Broadcasting-Cable DVB-C standard developed for cable television networks.

16. Transmission means according to claim 12, wherein said data processing means and said quadrature amplitude modulation means are arranged for processing a plurality of information signals on a plurality of carrier wave signal channels, in particular a plurality of one to four channels.

17. Transmission means according to claim 12, wherein said digital data processing means comprise optical-to-electrical conversion means for processing an optical digital information signal.

18. Transmission means according to claim 12, wherein said quadrature amplitude modulation means are provided with at least one coaxial output connector.

19. Transmission means according to claim 12, wherein said digital data processing means comprise digital synchronization means, digital coding means, and digital format adaptation and mapping means in a cascade arrangement.

20. Transmission means according to claim 12, wherein said transmission means are provided with a command control input for remote management and adjustment of various parameter settings of said transmission means.

21. Transmission means according to claim 12, wherein said transmission means are constructed in the form of one of a group comprising an application specific integrated semiconductor circuit (ASIC) and a Field Programmable Gate Array (FPGA).

22. A coaxial cable transmission system in a building, such as in an office block and a hotel, said coaxial cable transmission system comprising digital data processing means and quadrature amplitude modulation means, wherein said quadrature amplitude modulation means are arranged for directly modulating a digital information signal processed by said data processing means on a carrier wave signal to be transmitted in a frequency range above approximately 100 MHz.
